(19) United States
(12) Patent Application Publication
(10) Pub. No.: US 2024/0419286 A1
(43) Pub. Date: Dec. 19, 2024

(54) IRREGULAR-SHAPED CAPACITIVE SENSORS AND LOCATIONS OF TOUCH EVENTS AT THE SAME

(71) Applicant: Microchip Touch Solutions Limited, Wokingham (GB)

(72) Inventors: William J. Liddell, Petersfield (GB); Nigel Hinson, Lymington (GB)

(21) Appl. No.: 18/337,359

(22) Filed: Jun. 19, 2023

Related U.S. Application Data
(60) Provisional application No. 63/366,682, filed on Jun. 20, 2022.

(51) Int. Cl. G06F 3/044; G01D 5/241

(52) U.S. Cl. CPC G06F 3/0446; G01D 5/241

(57) ABSTRACT

A method includes: changing a geometry of a capacitive sensor design from a first geometry to a second geometry, the second geometry different than the first geometry; and obtaining executable instructions to transform a location identifier of a touch event from a first location identifier associated with the first geometry to a second location identifier associated with the second geometry.

### CROSS-REFERENCE TO RELATED APPLICATION

This application claims the benefit of the priority date of U.S. Provisional Patent Application No. 63/366,682, filed Jun. 20, 2022, and titled “CAPACITIVE SENSOR GEOMETRY DISTORTION TO DESIGN A CAPACITIVE SENSOR HAVING AN IRREGULAR GEOMETRY, AND CAPACITIVE SENSORS HAVING IRREGULAR GEOMETRIES,” the entire contents and disclosure of which is incorporated herein by this reference.

### FIELD

Examples relate to capacitive sensors, irregular-shaped capacitive sensors, and reporting locations of touch events at the same.

### BACKGROUND

Capacitive sensors are utilized in a variety of operational contexts, such as touch screens, touch pads, and capacitive buttons, without limitation.

### BRIEF DESCRIPTION OF THE DRAWINGS

To easily identify the discussion of any particular element or act, the most significant digit or digits in a reference number refer to the figure number in which that element is first introduced.

FIG. 1A is a schematic diagram depicting a graphical representation of a capacitive sensor design, and more specifically, a capacitive sensor design to be distorted in accordance with one or more examples.

FIG. 1B is a schematic diagram depicting a graphical representation of a capacitive sensor design, and more specifically, a distorted capacitive sensor design in accordance with one or more examples.

FIG. 2 is a flow-diagram depicting a process to distort a geometry of a capacitive sensor design from a first, regular geometry, to a second, irregular geometry, in accordance with one or more examples.

FIG. 3 is a flow-diagram depicting a process to distort a geometry of a capacitive sensor design, in accordance with one or more examples.

FIG. 4 is a flow-diagram depicting a process to change a geometry of a capacitive sensor design from a first geometry to a second geometry, in accordance with one or more examples.

FIG. 5 is a flow-diagram depicting a process to map the geometry of the reference design to the geometry of the target design, in accordance with one or more examples.

FIG. 6 is a flow-diagram depicting a process to set respective node areas of the mapped reference design to have a uniform size, in accordance with one or more examples.

FIG. 7 is a flow-diagram depicting a process to scale dimensions of respective node areas of the mapped reference design according to the scaling factor, in accordance with one or more examples.

FIG. 8 is a flow-diagram depicting a process to finish respective sensor node geometries of the mapped reference design, in accordance with one or more examples.

FIG. 9A and FIG. 9B are graphical representations of an outline of a target capacitive sensor design having an irregular geometry.

FIG. 10A is a graphical representation of a basic grid, in accordance with one or more examples.

FIG. 10B is a graphical representation of the basic grid of FIG. 10A remapped, in accordance with one or more examples.

FIG. 10C is a graphical representation of the basic touch sensor panel (TSP) pattern that corresponds to the basic grid of FIG. 10A, in accordance with one or more examples.

FIG. 10D is a graphical representation of the TSP pattern of FIG. 10C remapped, in accordance with one or more examples.

FIG. 11A is a graphical representation of a basic grid having 0.7 horizontal ratio, in accordance with one or more examples.

FIG. 11B is a graphical representation of the basic grid having the 0.7 horizontal ratio of FIG. 11A remapped, in accordance with one or more examples.

FIG. 11C is a graphical representation of a basic TSP pattern having a 0.7 horizontal ratio, in accordance with one or more examples.

FIG. 11D is a graphical representation of the TSP pattern having a 0.7 horizontal ratio of FIG. 11C remapped, in accordance with one or more examples.

FIG. 12A, FIG. 12B and FIG. 12C are graphical representations depicting rough sensor node geometries for a 2-layer sensor node design, in accordance with one or more examples.

FIG. 13A and FIG. 13B are graphical representations depicting a distorted capacitive sensor design that includes sensor nodes having constructed geometries, in accordance with one or more examples.

FIG. 14A, FIG. 14B, and FIG. 14C are schematic designs depicting portions of sensor nodes including intersections of electrodes and crossover elements, in accordance with one or more examples.

FIG. 15 is a graphical representation depicting a finished, distorted capacitive sensor design, in accordance with one or more examples.

FIG. 16 is a block diagram depicting a system to distort a geometry of a capacitive sensor design from a first, regular geometry, to a second, irregular geometry, in accordance with one or more examples.

FIG. 17 is a block diagram depicting a system to detect touches at an irregular-shaped sensor, in accordance with one or more examples.

FIG. 18 is a flow diagram depicting a process for detecting a touch event at an irregular-shaped capacitive sensor, in accordance with one or more examples.

FIG. 19 is a block diagram of a circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In this description the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be used in this description interchangeably with the term “coupled,” and have the same meaning unless expressly indicated otherwise or the context would indicate otherwise to a person having ordinary skill in the art.

As used herein, the term “geometry” means the shape and relative arrangement of the parts of something. As used herein, the term “irregular geometry” means a geometrical shape that is not rectangular. Non-limiting examples include geometrical shapes that include uneven sides, uneven angles, or uneven curves. As used herein, the term “irregularly shaped” means “having an irregular geometry” unless expressly stated otherwise or the specific context in which the term is used herein would indicate otherwise to a person having ordinary skill in the art.

In a typical capacitance sensor arrangement for capacitance sensing, electrodes are respectively arranged in a grid of rows and columns (sometimes referred to as “X electrodes” and “Y electrodes”), and intersections of the X electrodes and Y electrodes are referred to as a “sensor node.” When an alternating current stimulus is applied to the capacitance sensor, the electrodes measure a capacitance. A conductive object, such as a finger or stylus, is in suitable proximity to (e.g., near or touching, without limitation) a sensor node, at least some of the electrodes measure a different capacitance—i.e., measured capacitance of those electrode changes. Capacitance sensing involves detecting such changes in measured capacitance.

In a typical two-dimensional (2D) arrangement of a capacitance sensor (“sensor”), the grid has a rectangular shape and the respective sensor nodes of the sensor have a uniform, rectangular shape. A typical touch controller is pre-configured to detect changes in capacitance at a sensor having a rectangular shape. Symmetry is convenient for capacitance sensing (especially mutual capacitance sensing) as effects of capacitive loads (e.g., a conductive object in suitable proximity to a sensor node) is balanced.

Sometimes it may be desirable to have a sensor that has a non-rectangular shape (e.g., trapezoidal or elliptical, and regular or irregular, without limitation). As a non-limiting example, a non-rectangular sensor may be paired with a non-rectangular shaped display, touch pad, button, or slider.

A touch controller pre-configured to detect changes in capacitance at a sensor having a rectangular shape may produce incorrect or inaccurate results if paired with a sensor that has a non-rectangular shape. For example, a touch controller that produces cartesian coordinates (“coordinates”) associated with the location of a touch event at a sensor may produce coordinates that are different than the actual coordinates of the location of a touch event at a non-rectangular sensor.

One or more examples relate, generally, to distorting a geometry of a capacitive sensor design from a first, regular geometry, to a second, irregular geometry, and methods, apparatuses, and systems for doing the same. A distorted capacitive sensor design can dictate the dimensions of a physical capacitive sensor made based on the design.

One or more examples relate, generally, to producing a location identifier (e.g., cartesian coordinates, without limitation) for a touch event at a capacitive sensor having an irregular geometry, configuring controllers to produce location identifiers for a touch event at a capacitive sensor having an irregular geometry, and methods, apparatuses, and systems for doing the same. The controller may be pre-configured to produce a location identifier for a capacitive sensor having a regular geometry and one or more examples may relate to changing a location identifier for a capacitive sensor having a regular geometry to a location identifier for a capacitive sensor having an irregular geometry.

One or more examples relate, generally, to a controller configured to produce a location identifier for a touch event at a capacitive sensor having an irregular geometry, and capacitive sensing systems including the same.

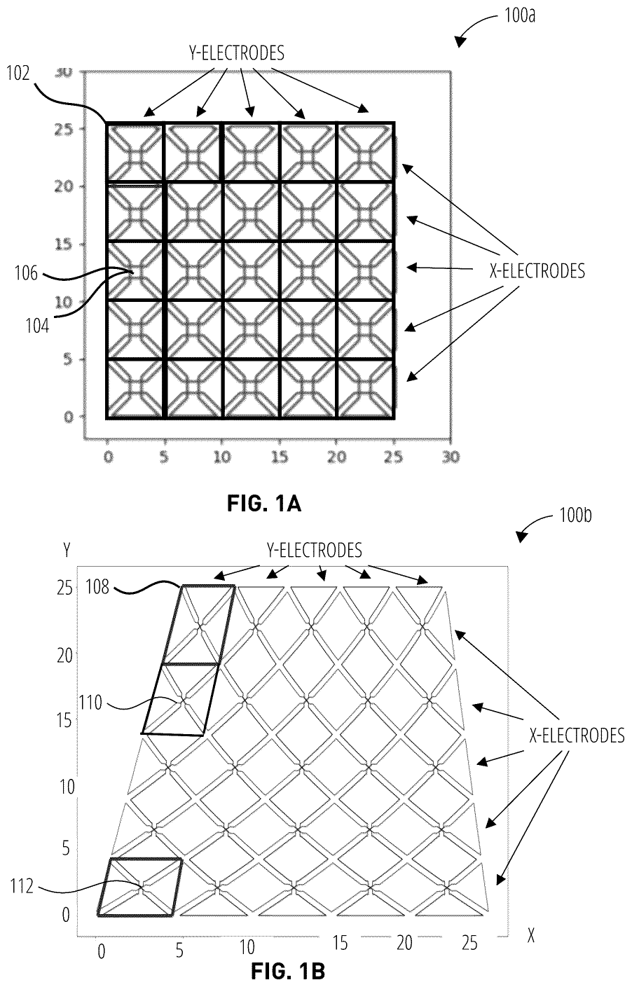

FIG. 1A and FIG. 1B are graphical representations of capacitive sensor design pre-distortion (a “capacitive sensor design-to-be-distorted”) and post-distortion (a “distorted capacitive sensor design”), in accordance with one or more examples.

Each of FIG. 1A and FIG. 1B depicts an X-axis and a Y-axis defining an XY-plane. The numbers on the X-axis and Y-axis increase at a linear scale from the origin. XY pairs of these numbers can be used to denote the locations of specific points on the XY-plane as unique coordinates according to a coordinate system. These numbers can be used to represent distances from the origin. In a Cartesian coordinate system, the interval spacing between numbers is uniform. The coordinate system defined by the X-axis and Y-Axis depicted by FIG. 1A and FIG. 1B is a Cartesian coordinate system. By convention, height is the distance on the Y-axis and width is the distance on the X-axis, but use of this convention herein is merely for convenience, and is not intended to limit the scope of this disclosure in any way.

FIG. 1A is a graphical representation of a capacitive sensor design 100a to be distorted in accordance with one or more examples, and may also be referred to herein as capacitive sensor design to-be-distorted 100a. A capacitive sensor design to be distorted may also be referred to herein as a “reference capacitive sensor design” or just “reference design.”

The capacitive sensor design to-be-distorted 100a includes sensor 102. Sensor 102 includes X-electrodes and Y-electrodes arranged in a grid. The X-electrodes and Y-electrodes may be in, or form, a same layer or different layers with one overlaying the other. Respective intersections 104 of the X-electrodes and Y-electrodes form respective sensor nodes 106 of sensor 102.

Sensor 102 has a regular geometry. Specifically, sensor 102 has uniform dimensions: the height of sensor 102 is 25, the width of sensor 102 is 25, the length of each column of electrodes is 25 and the length of each row of electrodes is 25. Further, respective rows and columns of sensor 102 have the same numbers of sensor nodes, and respective sensor nodes have the same area (respective areas of nodes a “node area”). The coordinate plane of capacitive sensor design to-be-distorted 100a and a geometry thereof is the XY-plane defined by the outline of sensor 102.

Since the node areas and number of sensor nodes of sensor nodes 106 are uniform, the respective capacitances and capacitance values (e.g., a value generated in response to a capacitance measurement, without limitation) of nodes of sensor 102, in the absence of a touch event (i.e., absence of an object in suitable proximity to one or more sensor nodes to influence capacitance measurements) may be represented by the uniform parallel plate capacitor formula

$$C = \frac{∈ A}{d} = \frac{{∈}_{0} {∈}_{r} A}{d} ,$$

where C is the capacitance measured in Farads, A is the area of one of the parallel plates measured in square meters, ∈ is the permittivity of the electrolyte (material between the plates, e.g., air) defined by the vacuum permittivity ∈₀ multiplied by the relative permittivity ∈ᵣ, and d is distance between the parallel plates (typically the thickness of a touch cover).

FIG. 1B is a graphical representation of a capacitive sensor design 100b distorted in accordance with one or more examples, and may also be referred to herein as distorted capacitive sensor design 100b. Distorted capacitive sensor design 100b was produced by distorting the geometry of sensor 102 of capacitive sensor design to-be-distorted 100a, as discussed below. In one or more examples, a distorted capacitive sensor design may correspond to a target capacitive sensor design. A target capacitive sensor design may also be referred to herein as a “target design.”

Distorted capacitive sensor design 100b includes distorted sensor 108. which includes X-electrodes and Y-electrodes arranged in a grid. The X-electrodes and Y-electrodes may be in, or form, a same layer or different layers with one overlaying the other. Respective intersections of X-electrodes and Y-electrodes of distorted sensor 108 form respective sensor nodes of distorted sensor 108.

Distorted sensor 108 has an irregular geometry. More specifically, distorted sensor 108 does not have uniform dimensions. The top width is about 20 and the bottom width is about 25 and the lengths of respective rows of sensor 102 increases from the bottom row, which has a width of about 25, to the top row which has a width of about 20. The lengths of the left and right sides of distorted sensor 108 are different and may be determined using the formula for determining the lengths of the side of a right triangle, n=√(l²+m²), where ‘n’ is the length of the hypotonus and ‘l’ and ‘m’ are the lengths of the other sides of the right triangle.

Locations of points on a region defined by distorted sensor 108 may be represented according to the Cartesian coordinate system of capacitive sensor design to-be-distorted 100a, and may also be represented according to another coordinate system that is a distorted version of the coordinate system of capacitive sensor design to-be-distorted 100a. In the distorted coordinate system, the interval spacing on the X and Y axis are not uniform. The interval spacing of the distorted coordinate system is defined by the interval spacing in the X and Y directions between intersections of X and Y electrodes of distorted capacitive sensor design 100b, which do not align with the interval spacings of intersections of X and Y electrodes of capacitive sensor design to-be-distorted 100a nor the interval spacings of numbers on the X and Y axis.

Distorted capacitive sensor design 100b is associated with the Cartesian coordinate system of FIG. 1A, and it is also associated with a different coordinate system than capacitive sensor design to-be-distorted 100a.

Respective areas of sensor nodes of distorted sensor 108 are substantially uniform (i.e., here node areas are substantially uniform if the difference from minimum area to maximum area is <25%), and respective geometries of the sensor nodes are, at least in some cases, different (e.g., respective heights or widths of the sensor nodes are different, without limitation) and so may not be substantially uniform. In the specific non-limiting example depicted by FIG. 1B, the geometry of sensor node 110 is different than the geometry of sensor node 112. The widths of sensor node 110 and sensor node 112 are different, and the heights of sensor node 110 and sensor node 112 are different. Notably, respective node areas of sensor node 110 and sensor node 112 are substantially the same (i.e., uniform, as discussed below).

The number of sensor nodes in each row of distorted sensor 108 is uniform and respective node areas of sensor nodes of distorted sensor 108 are substantially uniform, respective capacitances and capacitance values of X-electrodes and Y-electrodes of distorted sensor 108 in the absence of a touch are substantially uniform (capacitances are substantially uniform if the difference from minimum capacitance to maximum capacitance is ≤20%, though some variation higher or lower may be permitted based on specific operating conditions), based on the parallel plate capacitor formula (set forth above). Since capacitances are substantially uniform, the capacitive response to a touch is substantially uniform (i.e., here capacitive response to a touch is substantially uniform if the difference from min capacitance response to max capacitive response is <XYZ %). Since capacitive response to a touch is substantially uniform, a touch controller configured to detect touch events on a sensor having a regular geometry may reliably detect touch events on distorted sensor 108.

The differences, visual and discussed above, between capacitive sensor design to-be-distorted 100a and distorted capacitive sensor design 100b are representative of distortion applied to capacitive sensor design to-be-distorted 100a as discussed below.

If a touch controller configured to detect touches at sensor 102 were utilized to detect touches at distorted sensor 108, the coordinates used to represent locations of touch events detected by the touch controller would be associated with the coordinate plane of capacitive sensor design to-be-distorted 100a. For example, in the case of a touch event at the top right corner of distorted sensor 108, such a touch controller would output XY-coordinates (25,25), but the actual XY-coordinates would be (24, 25).

Since the coordinate planes are known for both a capacitive sensor design to-be-distorted 100a and a distorted capacitive sensor design 100b, transforms for changing coordinates associated with the coordinate plane of capacitive sensor design to-be-distorted 100a to coordinates associated with the coordinate plane of distorted capacitive sensor design 100b may be determined as discussed below.

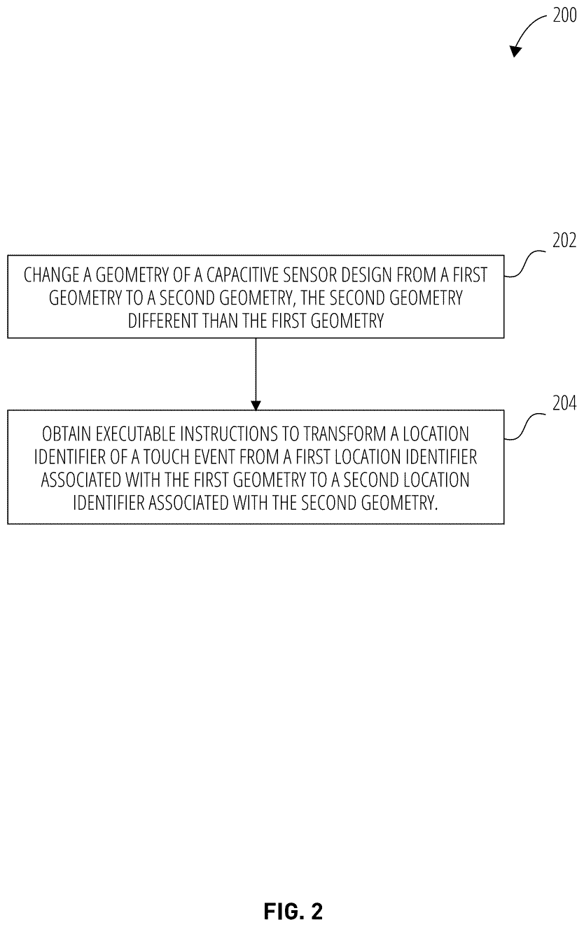

FIG. 2 is a flow-diagram depicting a process 200 to distort a geometry of a capacitive sensor design from a first, regular geometry, to a second, irregular geometry, in accordance with one or more examples. Process 200 is a non-limiting example of a process to distort capacitive sensor design to-be-distorted 100a to distorted capacitive sensor design 100b.

Although the example process 200 depicts a particular sequence of operations, the sequence may be altered without departing from the scope of the present disclosure. For example, some of the operations depicted may be performed in parallel or in a different sequence that does not materially affect the function of the process 200. In other examples, different components of an example device or system that implements the process 200 may perform functions at substantially the same time or in a specific sequence.

According to one or more examples, process 200 includes changing a geometry of a capacitive sensor design from a first geometry to a second geometry, the second geometry different than the first geometry at operation 202. In one or more examples, the first geometry may be a regular geometry and the second geometry may be an irregular geometry.

According to one or more examples, process 200 includes obtaining executable instructions (e.g., software, firmware, machine-executable instructions, without limitation) to transform a location identifier of a touch event from a first location identifier associated with the first geometry to a second location identifier associated with the second geometry at operation 204. Obtaining executable instructions includes, without limitation, generating executable instructions. In one or more examples, respective location identifiers are XY-coordinates according to a cartesian coordinate system. In one or more examples, the first location identifier is associated with the first geometry because it is associated with a coordinate plane of the first geometry. In one or more examples, the second location identifier is associated with the second geometry because it is associated with a coordinate plane of the second geometry based on an applied transform.

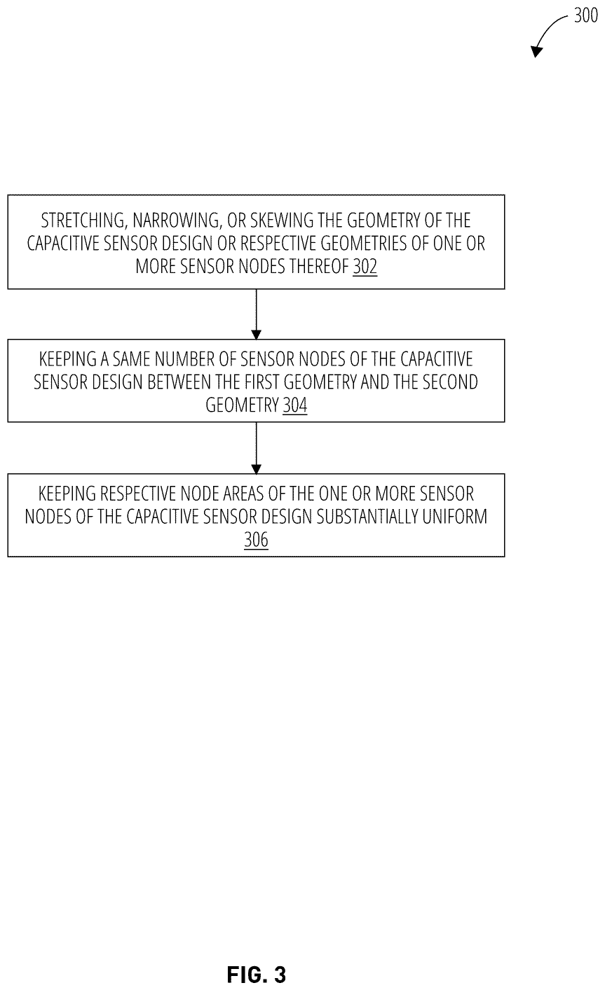

FIG. 3 is a flow-diagram depicting a process 300 to distort a geometry of a capacitive sensor design, in accordance with one or more examples.

Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to one or more examples, process 300 includes stretching, narrowing, or skewing the geometry of the capacitive sensor design or respective geometries of one or more sensor nodes thereof at operation 302. In one or more examples, stretching, narrowing, or skewing the geometry of the capacitive sensor design may include increasing or decreasing height, width or both of a region corresponding to the capacitive sensor design or sensor nodes thereof; increasing or decreasing the length of a respective column or row of the capacitive sensor design or sensor nodes thereof; rotating a region corresponding to a capacitive sensor design or sensor nodes thereof on an axis perpendicular thereto, or combinations and sub-combinations thereof.

According to one or more examples, process 300 includes keeping a same number of sensor nodes of the capacitive sensor design between the first geometry and the second geometry at operation 304.

According to one or more examples, process 300 includes keeping respective node areas of the one or more sensor nodes of the capacitive sensor design substantially uniform at operation 306.

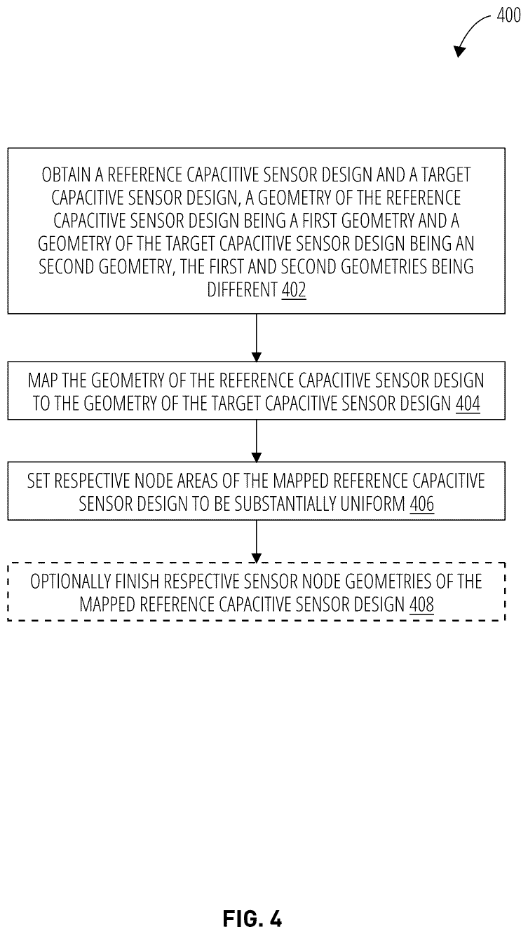

FIG. 4 is a flow-diagram depicting a process 400 to change a geometry of a capacitive sensor design from a first geometry to a second geometry, in accordance with one or more examples.

Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to one or more examples, process 400 includes obtaining a reference capacitive sensor design and a target capacitive sensor design at operation 402. The geometry of the reference capacitive sensor design is a first geometry and the geometry of the target capacitive sensor design being a second geometry. The first and second geometries are different, and may be, as a non-limiting example, a regular geometry and irregular geometry, respectively. The reference capacitive sensor design is a capacitive sensor design to be distorted. The target capacitive sensor design represents the requirements for the distorted capacitive sensor design. In theory, the distorted capacitive sensor design should match the target capacitive sensor design. The degree to which a distorted capacitive sensor design matches a target capacitive sensor design is a matter of design choice and may depend, as a non-limiting example, on a specific application or specific operating conditions of system including a capacitive sensor according to a distorted capacitive sensor design.

According to one or more examples, process 400 includes mapping the geometry of the reference capacitive sensor design to the geometry of the target capacitive sensor design at operation 404.

According to one or more examples, process 400 includes setting respective node areas of the mapped reference capacitive sensor design to be substantially uniform at operation 406.

According to one or more examples, process 400 includes finishing respective sensor node geometries of the mapped reference capacitive sensor design at operation 408. Here, “finishing” refers to acts taken, if any, to refine and complete the form, fit or function of sensor node geometries.

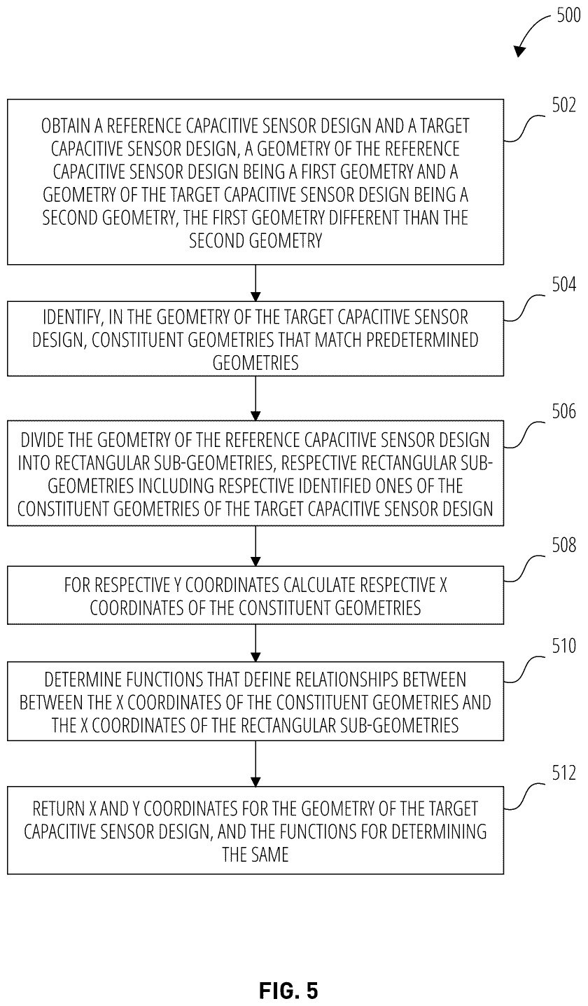

FIG. 5 is a flow-diagram depicting a process 500 to map the geometry of the reference design to the geometry of the target design, in accordance with one or more examples.

Although the example process 500 depicts a particular sequence of operations, the sequence may be altered without departing from the scope of the present disclosure. For example, some of the operations depicted may be performed in parallel or in a different sequence that does not materially affect the function of the process 500. In other examples, different components of an example device or system that implements the process 500 may perform functions at substantially the same time or in a specific sequence.

According to one or more examples, process 500 includes obtaining a reference capacitive sensor design and a target capacitive sensor design at operation 502. A geometry of the reference capacitive sensor design is a first geometry and a geometry of the target capacitive sensor design is a second geometry. The first and second geometries are different, and as non-limiting examples, may be a regular geometry and an irregular geometry, respectively.

According to one or more examples, process 500 includes identifying, in the geometry of the target capacitive sensor design, constituent geometries that match predetermined geometries at operation 504.

According to one or more examples, the method includes dividing the geometry of the reference capacitive sensor design into rectangular sub-geometries at operation 506. The respective rectangular sub-geometries include respective ones of the identified constituent geometries of the target capacitive sensor design.

According to one or more examples, process 500 includes, for respective Y coordinates, calculating respective X coordinates of the constituent geometries at operation 508.

According to one or more examples, process 500 includes determining functions that describe relationships between the X coordinates of the constituent geometries and the Y coordinates of the rectangular sub-geometries at operation 510.

According to one or more examples, process 500 includes returning XY coordinates for the geometry of the target capacitive sensor design, and the functions for determining the same at operation 512. The functions for determining the X and Y coordinates are the coordinate transforms.

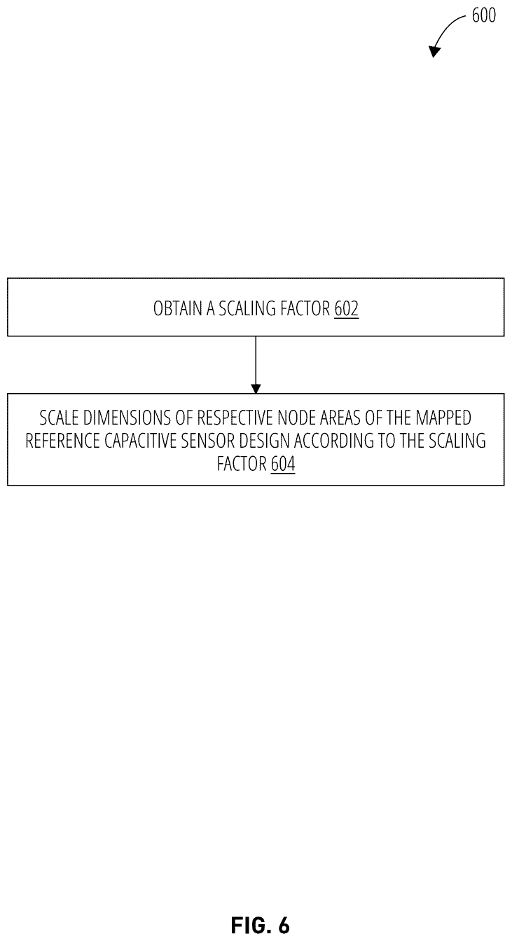

FIG. 6 is a flow-diagram depicting a process 600 to set respective node areas of the mapped reference design to be substantially uniform, in accordance with one or more examples.

Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence.

According to one or more examples, the method includes obtaining a scaling factor at operation 602.

According to one or more examples, the method includes scaling dimensions of respective node areas of the mapped reference design according to the scaling factor at operation 604.

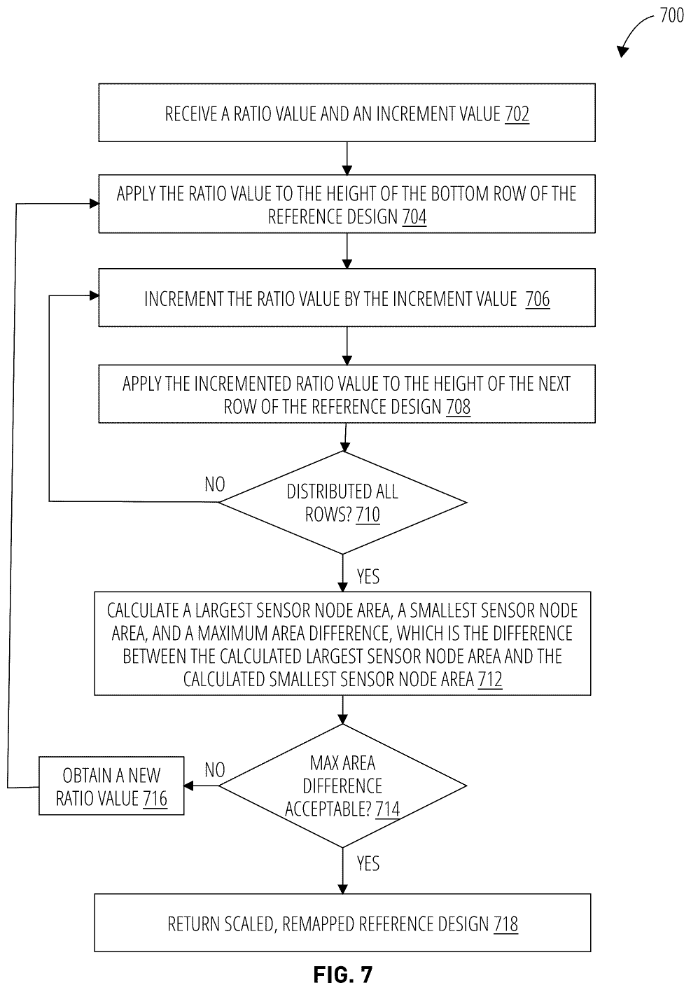

FIG. 7 is a flow-diagram depicting a process 700 to scale dimensions of respective node areas of the mapped reference design according to the scaling factor, in accordance with one or more examples.

Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

According to one or more examples, process 700 includes receiving a ratio value and an increment value at operation 702.

According to one or more examples, process 700 includes applying the ratio value to the height of the bottom row of the reference design at operation 704.

According to one or more examples, process 700 includes incrementing the ratio value by the increment value at operation 706.

According to one or more examples, process 700 includes applying the incremented ratio value to the height of the next row of the reference design at operation 708.

According to one or more examples, process 700 includes determining whether or not all rows were distributed at decision block 710. If process 700 determines “no” in response to decision block 710 then it loops back to operation 706 to increment the ratio value by an increment value and so on. If process 700 determines “yes” in response to decision block 710 then process 700 proceeds to decision block 712.

According to one or more examples, process 700 includes calculating a largest sensor node area, a smallest sensor node area, and a maximum area difference at decision block 712. The maximum area difference is calculated as the difference between the calculated largest sensor node area and the calculated smallest sensor node area. The largest sensor node area is the area of a respective sensor node having a largest area calculated by process 700, and the smallest sensor node area is the area of a further respective sensor node having a smallest area calculated by process 700.

According to one or more examples, process 700 includes determining whether or not the maximum area difference is acceptable at decision block 714. In one or more examples, determining whether maximum area difference is acceptable includes comparing a maximum area difference to a predetermined threshold value, and if the maximum area difference is greater than the predetermined threshold value then determine “yes,” and if the maximum area difference is less than the predetermined threshold value then determine “no.”

In some examples, the loops of process 700 may appear to be infinite because repeated iterations of process 700 do not result in a maximum area difference that is acceptable (e.g., below the predetermined threshold value, without limitation). So, in one or more examples, process 700 may include a counter and proceed to return an error condition if decision block 712 does not return a “yes” within a predetermined number of counts (i.e., current counter>a predetermined count threshold value).

If process 700 determines “no” at decision block 714 then process 700 proceeds to operation 716.

According to one or more examples, process 700 includes obtaining a new ratio value at operation 716 and then loops back to operation 704. Any suitable technique may be utilized to calculate a new ratio value. As a non-limiting example, a new ratio value may be calculated by increasing or decreasing the current ratio value according to a function or a predetermined step size. As a further non-limiting example, a new ratio value may be obtained from a look-up-table (LUT) that associates ratio values with current ratio values.

If process 700 determines “yes” at decision block 714, then process 700 proceeds to operation 718.

According to one or more examples, process 700 includes returning scaled, remapped reference capacitive sensor design at operation 718.

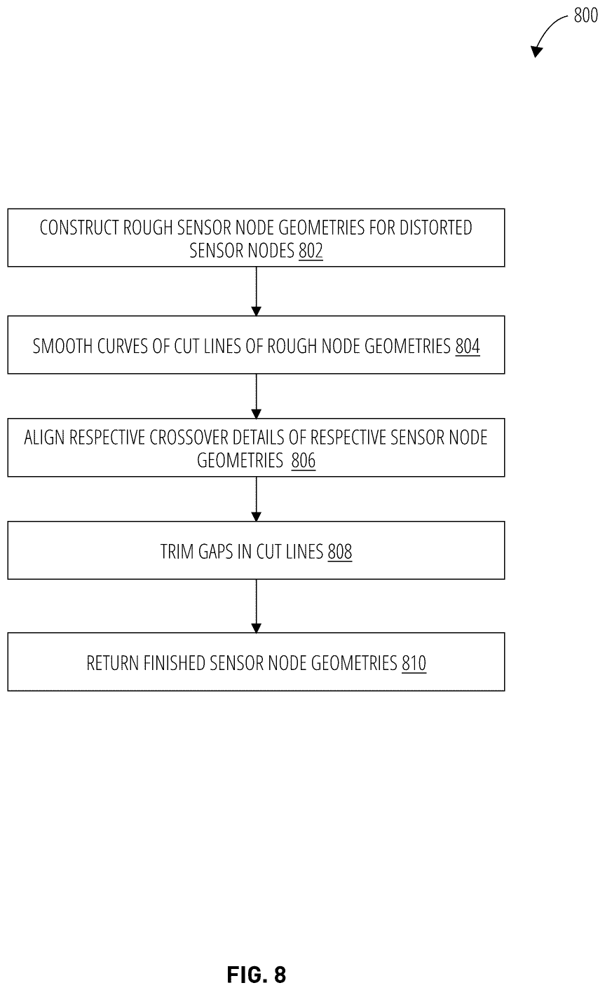

FIG. 8 is a flow-diagram depicting a process 800 to finish respective sensor node geometries of the mapped reference capacitive sensor design, in accordance with one or more examples.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to one or more examples, the method includes constructing rough sensor node geometries for distorted sensor nodes at operation 802.

According to one or more examples, the method includes smoothing curves of cut lines of rough node geometries at operation 804.

According to one or more examples, the method includes aligning respective crossover elements of respective sensor node geometries at operation 806. At an intersection of an X electrode and a Y electrode, typically one or both of the electrodes includes a discontinuity at the intersection. Crossover elements are a mass of conductive material that is arranged to provide a physical and electrical connection, across a space created by the discontinuity, between portions of the electrode having the discontinuity.

According to one or more examples, the method includes trimming gaps in cut lines at operation 808.

According to one or more examples, the method includes returning finished sensor node geometries at operation 810. The sensor node geometries have been smoothed, aligned, and trimmed to refine and complete the form, fit or function of sensor node geometries. The quantity of acts taken to refine and complete the form, fit or function of sensor node geometries, and quality of the results, will depend on specific operation conditions.

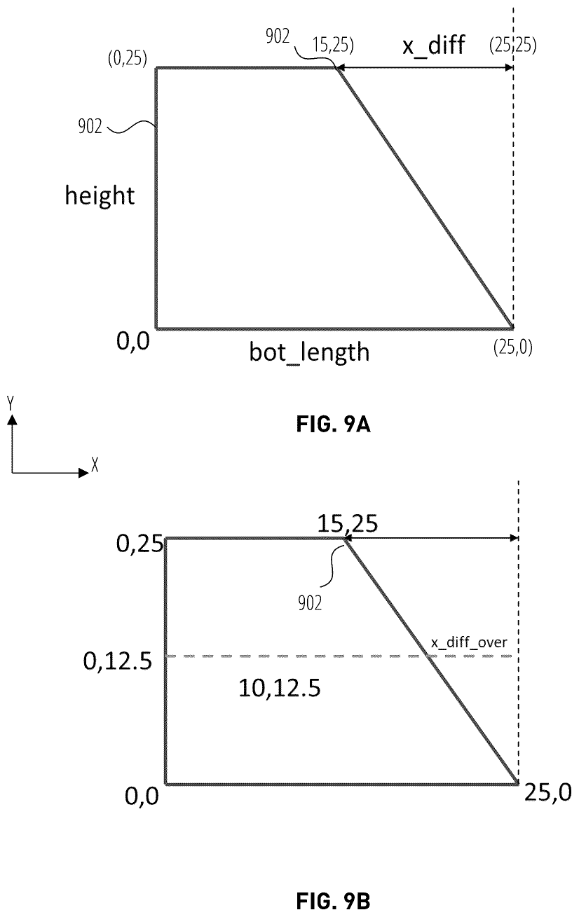

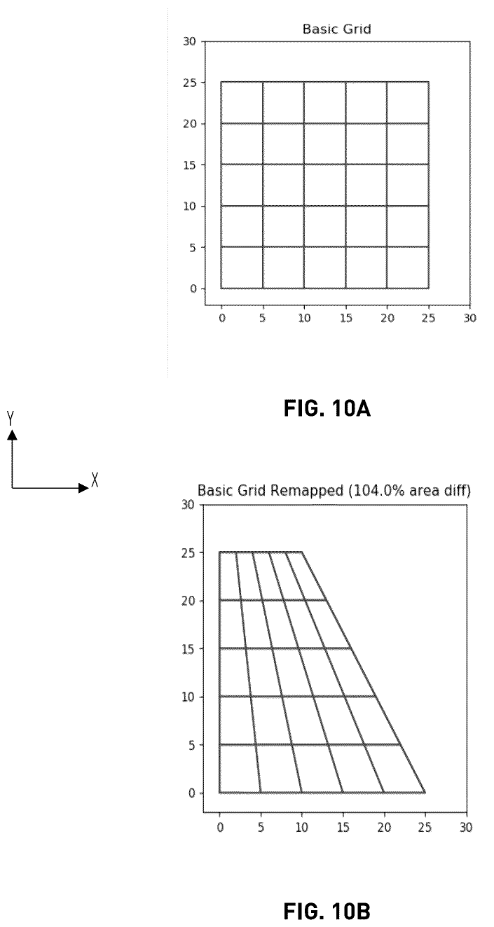

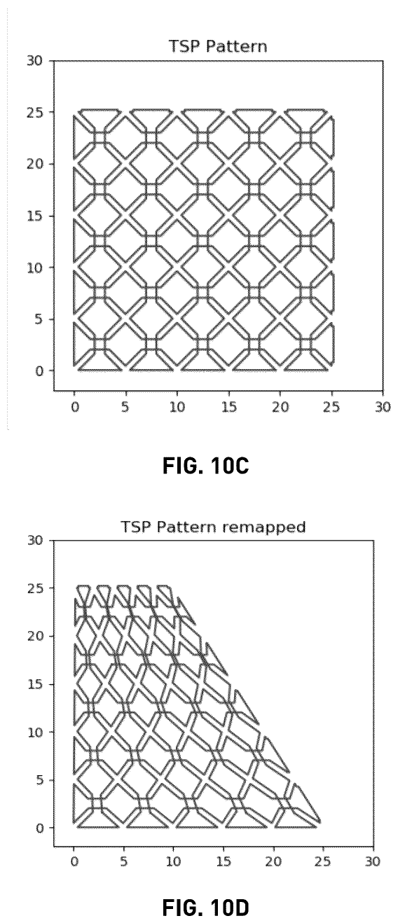

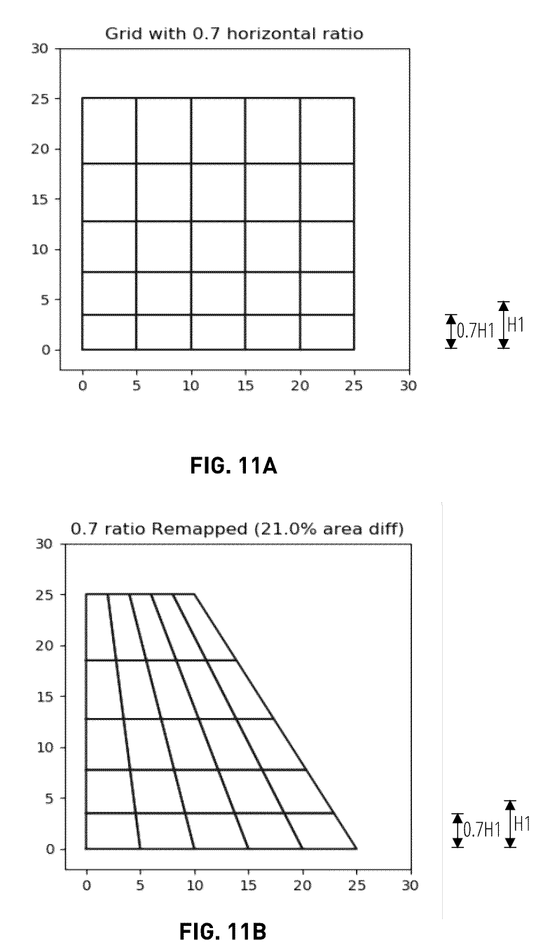

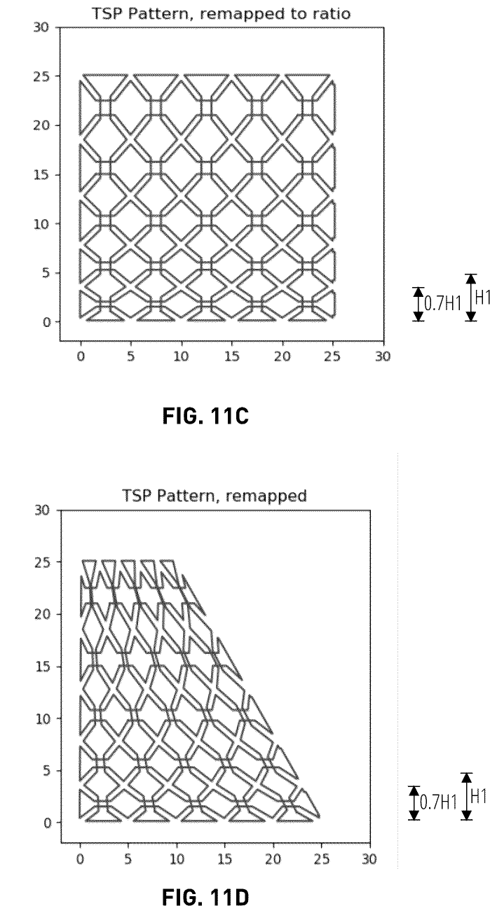

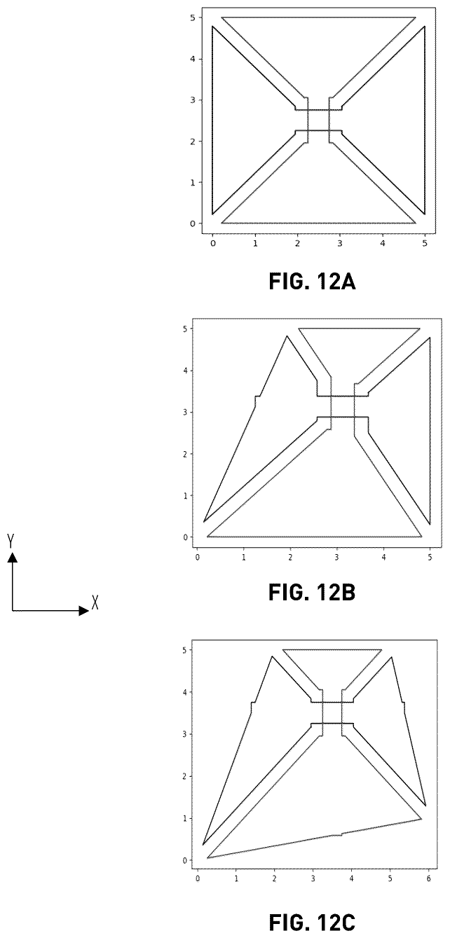

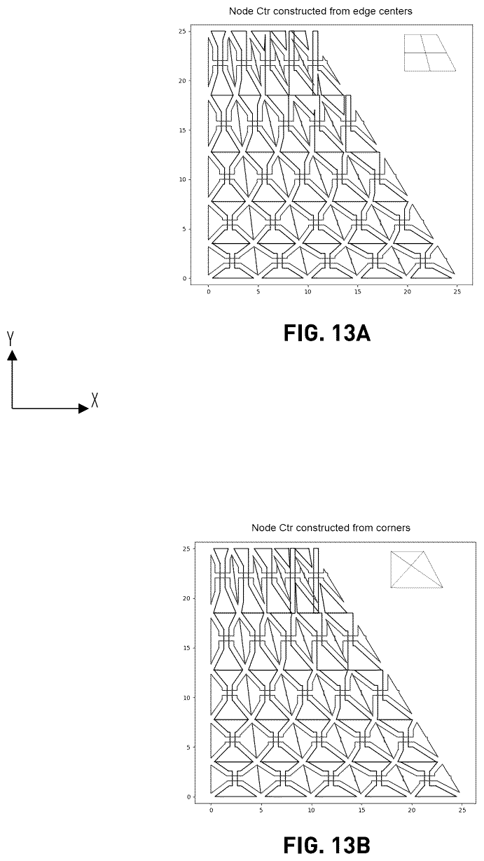

FIG. 9A, FIG. 9B, FIG. 10A, FIG. 10B, FIG. 11A, FIG. 11B, FIG. 12A, FIG. 12B, FIG. 12C, FIG. 13A and FIG. 13B together depict specific, non-limiting examples of intermediate graphical representations of a capacitive sensor design being distorted, in accordance with one or more examples.

FIG. 9A and FIG. 9B are graphical representations of a constituent geometry of a target capacitive sensor design identified when mapping the geometry of a reference capacitive sensor design to the geometry of a target capacitive sensor design as discussed with respect to FIG. 5 and process 500.

The outline is set (via the line from point at (15,25) to point at (25,0)) on an XY axis according to the cartesian coordinate system, and cartesian coordinates (0,0), (0,25), (15,25), (25,0), and (25,25) are depicted. The height of the target capacitive sensor design is the length from (0,0) to (0,25). The bottom length (bot_length) is the length from (0,0) to (25,0). The difference in the X direction between top right corner (coordinate (25,25)) and point 902 is “X_diff.” The coordinates of Point 902 are (15,25) so X_diff=10.

FIG. 9A and FIG. 9B depict aspects of determining a function that defines a relationship between a respective X coordinate of the constituent geometry and an X coordinate of a regular, rectangular sub-geometry of a reference capacitive sensor design.

In this example, new coordinates are calculated for XY-coordinates (10, 12.5).

A parameter ‘x_diff_over’ is calculated using the expression: x_diff_over=(x_diff/(y_height/y)). Where ‘y_height’ is the Y coordinate of the point using original XY-coordinates, and ‘y’ is the height of the point using the constituent geometry, and ‘x_diff’ is the difference between the X coordinate of the top right corner of the constituent geometry and an X coordinate of a regular, rectangular sub-geometry of a reference capacitive sensor design that is to be distorted to arrive at the constituent geometry of the target capacitive sensor design. With the values of these parameters plugged into the expression x_diff_over=(10/(25/12.5))=5.

A factor is calculated using the expression factor=bot_length/(bot_length−x_diff_over), where “bot_length” is the length of the bottom side of the constituent geometry of the target capacitive sensor design.

The “factor” is a function (also referred to herein as a “transform function”) that defines a relationship between the respective X coordinate of the constituent geometry and the X coordinate of the rectangular sub-geometry. In one or more examples, the factor is stored (e.g., in a look-up-table, without limitation) and may be utilized by a coordinate transform to change coordinates associated with a first geometry (the regular geometry) to coordinates associated with the second geometry (the irregular geometry).

With the values of bot_length and x_diff_over plugged into the expression, factor=25/(25−5)=1.25.

The new X coordinate is calculated using the expression X/factor, where “X” is the original X coordinate. Plugging in the values of these terms, new X coordinate=(10/1.666)=8. The new XY coordinate is (8, 12.5).

If a touch event occurred at point 902 of a sensor generated from a distorted capacitive sensor design as discussed herein, a touch controller configured to detect touches at a sensor having a regular geometry would output XY coordinates (25,25) because the sensor nodes of the reference capacitive sensor design were squished together in the x direction to generate the distorted capacitive sensor design. The distorted capacitive sensor design has the same number of sensor nodes as the reference capacitive sensor design, just more compactly arranged.

Applying the transform functions to the output coordinates changes the coordinates to a cartesian coordinate plane that is not uniform. Additionally or alternatively, the XY coordinates associated with the irregular geometry may be stored in a look-up-table (LUT) and searched using the XY coordinates associated with the irregular geometry.

FIG. 10A is a graphical representation of a basic grid, in accordance with one or more examples. FIG. 10B is a graphical representation of the basic grid of FIG. 10A remapped as discussed above.

The basic grid remapped of FIG. 10B depicts an outline of a target capacitive sensor design having an irregular geometry. The center points of respective cells of the grids correspond to sensor nodes, i.e., the center points of the cells of the grids correspond to intersections of X electrodes and Y electrodes. While the basic grid and basic grid remapped include the same number of cells, the cells of the basic grid remapped are not regular, rather, they are irregular (e.g., parallelograms and trapezoidal).

Notably, on the remapped grid there is a 104% area difference between min to max area of cells of the remapped grid. As mentioned above, it is desirable to reduce or eliminate differences in respective areas of sensor nodes, which sensor nodes are represented by the grid cells.

FIG. 10C is a graphical representation of a basic touch sensor panel (TSP) pattern. FIG. 10D is a graphical representation of the TSP pattern of FIG. 10C remapped, as discussed above.

The basic TSP pattern of FIG. 10C corresponds to the basic grid depicted by FIG. 10A and the TSP pattern remapped of FIG. 10D corresponds to the basic grid remapped in FIG. 10B.

The locations of the intersections of X and Y electrodes depicted in FIG. 10C and FIG. 10D correspond to the center points of the cells of the grid and grid remapped depicted in FIG. 10A and FIG. 10B, respectively.

Notably, the number of sensor nodes and intersections in the TSP pattern remapped is the same as the number of sensor nodes and intersections in the basic TSP pattern.

As mentioned above, it is desirable to reduce or eliminate differences in respective areas of sensor nodes.

FIG. 11A is a graphical representation of an example basic grid having a 0.7 horizontal ratio. FIG. 11B is a graphical representation of the basic grid of FIG. 11A remapped having a 0.7 horizontal ratio. The basic grid and basic grid remapped having the 0.7 horizontal ratio depicted by FIG. 11A and FIG. 11B, respectively, may be obtained, as a non-limiting example, by applying a scaling process, such as process 700, without limitation, to FIG. 10A and FIG. 10B.

The vertical ratio is the ratio of the height of the bottom row of cells in FIG. 11A to the height of the bottom row of cells pre-scaling, i.e., in FIG. 10A. Here, the ratio is 0.7, so the height of the bottom row of cells is equal to 0.7H1. While this example uses adjustments to vertical ratio, adjustments to horizontal ratio may be performed in the same manner. Further, adjustments to both vertical ratio and horizontal ratio may be performed.

FIG. 11C a graphical representation of an example basic TSP pattern having a 0.7 horizontal ratio. FIG. 11C a graphical representation of the example basic TSP pattern of FIG. 11C remapped having a 0.7 horizontal ratio. The basic TSP pattern and basic TSP pattern remapped having the 0.7 horizontal ratio depicted by FIG. 11C and FIG. 11D, respectively, may be obtained, as a non-limiting example, by applying a scaling process, such as process 700, whiteout limitation, to FIG. 10C and FIG. 10D.

In the case of the sensor nodes of the example depicted by FIG. 11D, gaps have been maintained but the node areas and geometries of the crossover elements are not uniform among the various sensor nodes, which may cause significant differences in capacitance values for respective sensor nodes. Setting the node areas and geometries of the sensor nodes of the mapped capacitive sensor design to be substantially uniform, generally reduces differences in capacitance values for respective sensor nodes.

FIG. 12A, FIG. 12B and FIG. 12C are graphical representations depicting rough sensor node geometries for a 2-layer sensor node design, in accordance with one or more examples.

The geometries depicted by FIG. 12A, FIG. 12B and FIG. 12C may be obtained, as a non-limiting example, by performing some or a totality of operations of process 800.

FIG. 12A depicts an example basic sensor node geometry for a basic sensor node design.

FIG. 12B depicts an example rough sensor node geometry for a first example distorted sensor node design.

FIG. 12C depicts an example rough sensor node geometry for a second example distorted sensor node design that is different than the first.

The example rough sensor node geometries depicted in FIG. 12A were constructed using the 4-corner point construction method utilized in computer-aided layout design, but this disclosure is not limited, and any suitable method may be utilized including the edge center-based construction method utilized in computer aided layout design, without limitation.

Other rough sensor node geometries may be created, these are just specific non-limiting examples that would fit some of the sensor nodes in the TSP pattern remapped depicted by FIG. 11B.

FIG. 13A and FIG. 13B are graphical representations depicting a distorted capacitive sensor design that includes sensor nodes having geometries constructed as discussed herein. The sensor nodes of the distorted capacitive sensor design depicted in FIG. 13A were constructed utilizing an edge-center construction method and the sensor nodes of the distorted capacitive sensor design depicted in FIG. 13B were constructed utilizing a 4-coroner point construction method.

Crossover element geometries are not aligned consistently in the distorted capacitive sensor designs depicted in FIG. 13A and FIG. 13B, which may cause significant differences in capacitance values of sensor nodes.

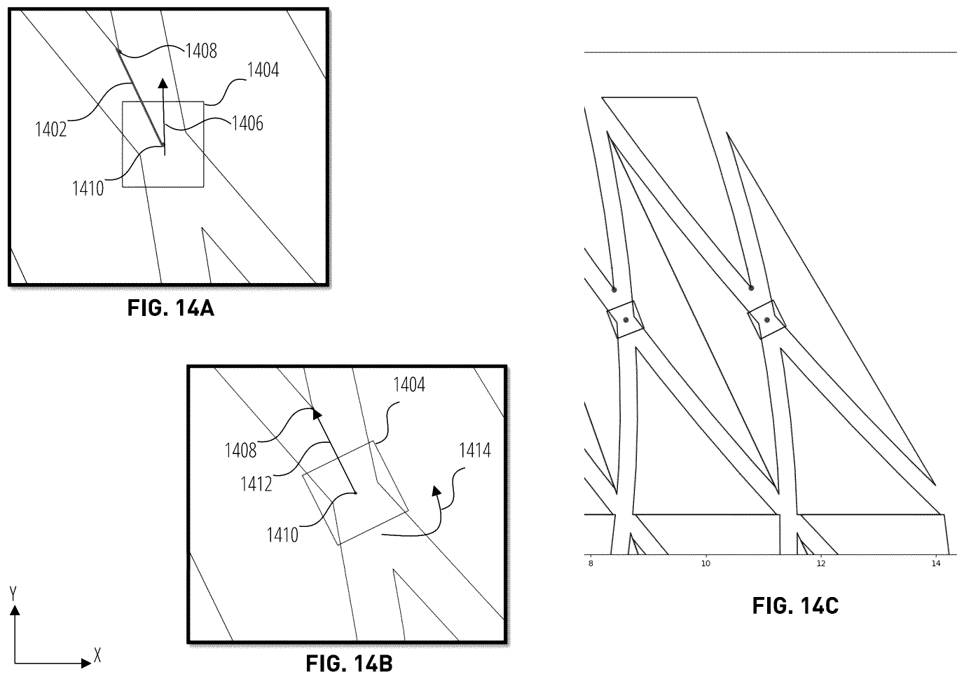

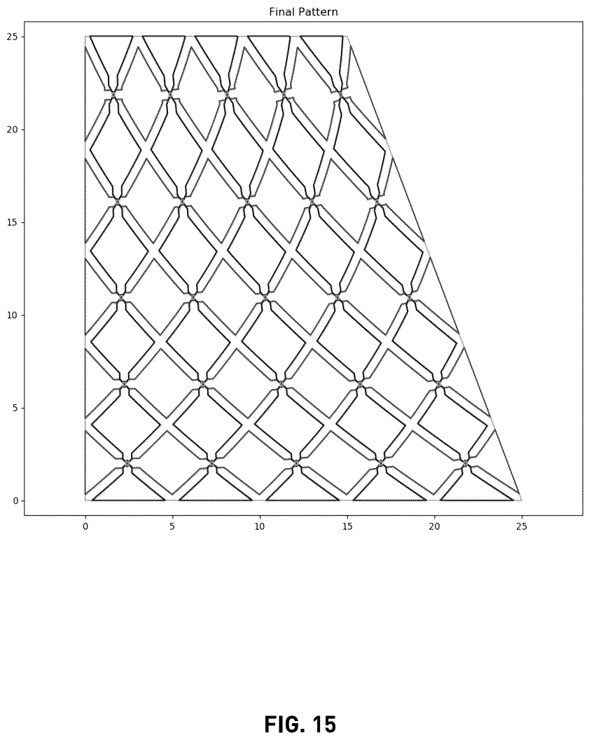

FIG. 14A, FIG. 14B, and FIG. 14C are schematic designs depicting portions of sensor nodes including intersections of electrodes and crossover elements. FIG. 14A illustrates a case where the crossover elements of sensor nodes do not exhibit uniform alignment with respect to segment tips, as discussed below.

As depicted in FIG. 14A, a crossover element 1404 is arranged in a direction represented by arrow 1406 that extends from center point 1410 of crossover element 1404 through a midpoint of a line segment that defines a side of a box that represents the crossover element 1404. A desired alignment is represented by alignment line 1402, which extends from center point 1410 to segment tip 1408, representing the direction crossover element 1404 should be aligned. Any like side of the boxes representing the crossover elements can be chosen for orientation as long as the crossover elements have the same geometry.

As depicted in FIG. 14B, crossover element 1404 is rotated about an axis (the axis is through center point 1410 perpendicular to the page) in the direction depicted by arrow 1414 until it is oriented in the direction depicted by arrow 1412, which is a ray from center point 1410 that passes through a midline of the edge of 1404 to segment tip 1408. When it is oriented in this way, the crossover element 1404 is oriented in a way that is aligned with the segment tip 1408. Generally speaking, it is desirable for the crossover elements to exhibit uniform orientation, whether with respect to the segment tips or another like reference.

FIG. 14C depicts several sensor node portions that include crossover elements uniformly in alignment with segment tips as discussed above.

FIG. 15 is a graphical representation depicting an example distorted capacitive sensor design pattern finished as discussed, above.

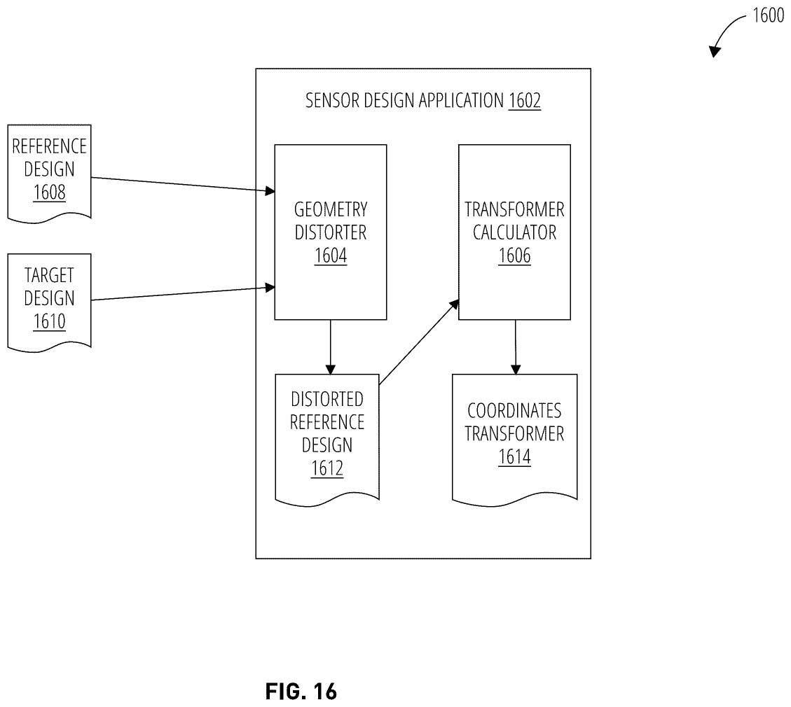

FIG. 16 is a block diagram depicting a system 1600 to distort a geometry of a capacitive sensor design from a first, regular geometry, to a second, irregular geometry, in accordance with one or more examples.

System 1600 includes sensor design application 1602. Sensor design application 1602 includes geometry distorter 1604, transformer calculator 1606, distorted reference design 1612 and coordinates transformer 1614.

Sensor design application 1602 may be, as non-limiting examples, a software application that executes on a local computer or a remote computer, or a service hosted at a server-computer or at cloud computing environment.

Geometry distorter 1604 may be, as non-limiting examples, a software module, routine, sub-routine, or package of sensor design application 1602. Geometry distorter 1604 receives a reference design 1608 and target design 1610, which are capacitive sensor design, and generates a distorted reference design 1612 at least partially responsive to the reference design 1608 and target design 1610. As a non-limiting example, geometry distorter 1604 may generate distorted reference design 1612 in response to performing some or a totality of operations discussed with respect to process 200, process 300, process 400, process 500, process 600, process 700, or process 800, or any combination or subcombination thereof.

Transformer calculator 1606 may be, as non-limiting examples, a software module, routine, sub-routine, or package of sensor design application 1602 or geometry distorter 1604. Transformer calculator 1606 receives distorted reference design 1612 and generates coordinates transformer 1614. As a non-limiting example, transformer calculator 1606 may be generated coordinates transformer 1614 in response to performing some or a totality of operations discussed with respect to process 500, or any combination or subcombination thereof.

Coordinates transformer 1614 is a set of executable instructions for changing a set of coordinates generated by a touch controller that's configured for use with a regular shaped sensor to coordinates associated with an irregular-shaped sensor. In one or more examples, a coordinates transformer 1614 generated by transformer calculator 1606 may be software, firmware, or microcode that is executable, at least in part, by a processing core of a microcontroller or by an integrated circuit (IC) more generally.

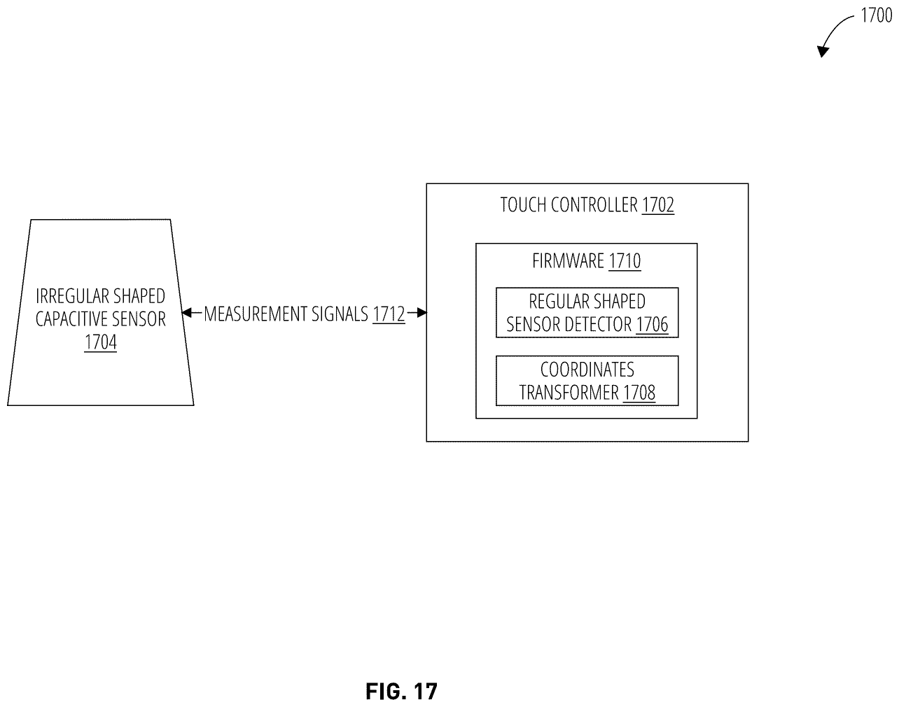

FIG. 17 is a block diagram depicting a system 1700 to detect touches at an irregular-shaped capacitive sensor, in accordance with one or more examples.

System 1700 includes touch controller 1702 and irregular-shaped capacitive sensor 1704. Touch controller 1702 includes firmware 1710, including regular shaped sensor detector 1706 and sensor coordinates transformer 1708. Regular shaped sensor detector 1706 is firmware for performing touch measurement and detection at touch controller 1702. Generally speaking, regular shaped sensor detector 1706 detects a touch at a regular shaped capacitive sensor and generates coordinates for a Cartesian coordinate system. Coordinates transformer 1708 is firmware to change coordinates generated by a touch controller (e.g., touch controller 1702, without limitation) configured to generate coordinates for a Cartesian coordinate system such as regular shaped sensor detector 1706, to coordinates that are associated with an irregular geometry, specifically, the irregular geometry of irregular-shaped capacitive sensor 1704. Coordinates transformer 1708 may be a coordinates transformer 1614 generated by transformer calculator 1606. As non-limiting examples, coordinates transformer 1708 may be a non-limiting example of a coordinates transformer 1614 generated by transformer calculator 1606, or generated via a process 500.

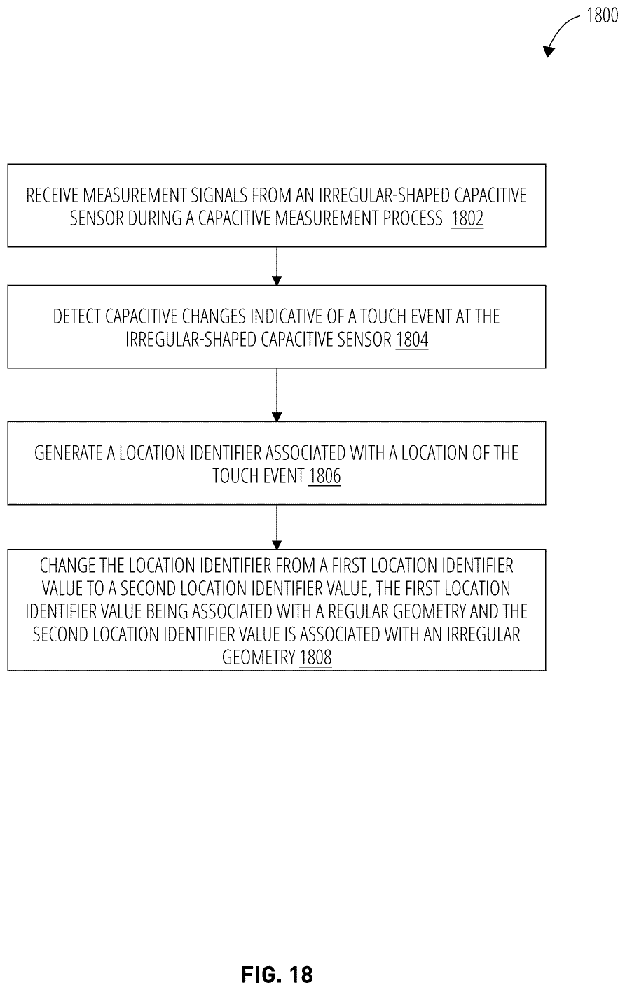

FIG. 18 is a flow diagram depicting a process 1800 for detecting a touch event at an irregular-shaped capacitive sensor and reporting a location of the same, in accordance with one or more examples. Some or a totality of the operations of process 1800 may be performed, as a non-limiting example at system 1700.

Although the example process 1800 depicts a particular sequence of operations, the sequence may be altered without departing from the scope of the present disclosure. For example, some of the operations depicted may be performed in parallel or in a different sequence that does not materially affect the function of the process 1800. In other examples, different components of an example device or system that implements the process 1800 may perform functions at substantially the same time or in a specific sequence.

According to some examples, the method includes receiving measurement signals from an irregular-shaped capacitive sensor during a capacitive measurement process at operation 1802.

According to some examples, the method includes detecting capacitive changes indicative of a touch event at the irregular-shaped capacitive sensor at operation 1804.

According to some examples, the method includes generating a location identifier associated with a location of the touch event at operation 1806.

According to some examples, the method includes changing the location identifier from a first location identifier value to a second location identifier value, the first location identifier value being associated with a regular geometry and the second location identifier value is associated with an irregular geometry at operation 1808. In one or more examples, changing the location identifier from the first location identifier value to the second location identifier value may include assigning new coordinate values, or generating a further location identifier with the second location identifier value. In one or more examples, a changed location identifier or a further location identifier, as the case may be, may be utilized to report the touch event.

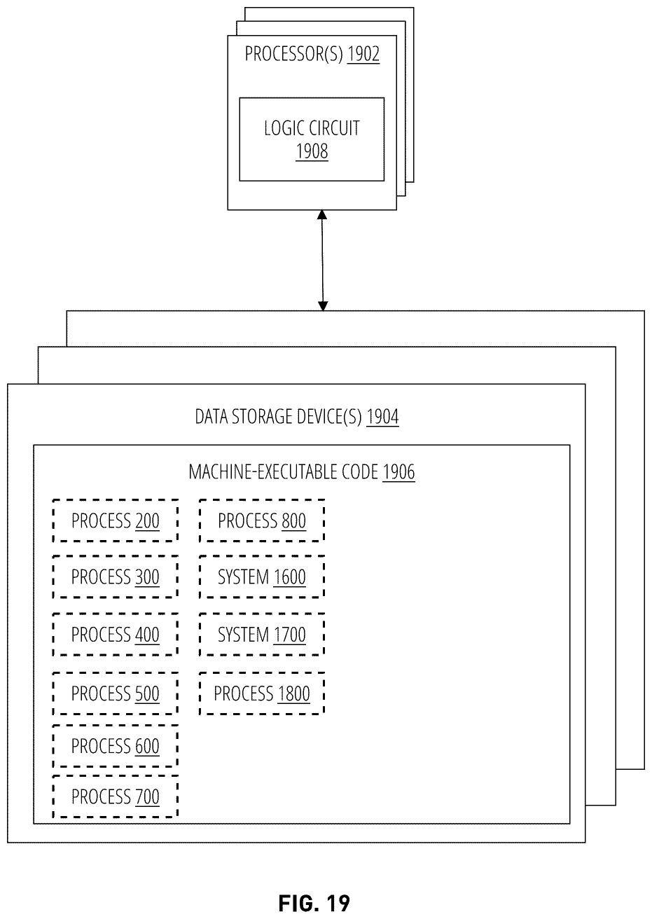

It will be appreciated by those of ordinary skill in the art that functional elements of examples disclosed herein (e.g., functions, operations, acts, processes, or methods) may be implemented in any suitable hardware, software, firmware, or combinations thereof. FIG. 19 illustrates non-limiting examples of implementations of functional elements disclosed herein. In some examples, some or all portions of the functional elements disclosed herein may be performed by hardware capable of carrying out the functional elements.

FIG. 19 is a block diagram of a circuitry that, in some examples, may be used to implement various functions, operations, acts, processes, or methods disclosed herein. The circuitry includes one or more processors 1902 (sometimes referred to herein as “processors 1902”) operably coupled to one or more data storage devices 1904 (sometimes referred to herein as “storage 1904”). The storage 1904 includes machine-executable code 1906 stored thereon and the processors 1902 include logic circuit 1908. The machine-executable code 1906 information describing functional elements that may be implemented by (e.g., performed by) the logic circuit 1908. The logic circuit 1908 is adapted to implement (e.g., perform) the functional elements described by the machine-executable code 1906. The circuitry, when executing the functional elements described by the machine-executable code 1906, should be considered as special purpose hardware for carrying out functional elements disclosed herein. In some examples the processors 1902 may perform the functional elements described by the machine-executable code 1906 sequentially, concurrently (e.g., on one or more different hardware platforms), or in one or more parallel process streams.

When implemented by logic circuit 1908 of the processors 1902, the machine-executable code 1906 adapts the processors 1902 to perform operations of examples disclosed herein. By way of non-limiting example, the machine-executable code 1906 may adapt the processors 1902 to perform some or a totality of operations of one or more of: process 200, process 300, process 400, process 500, process 600, process 700, process 800, or process 1800.

Also by way of non-limiting example, the machine-executable code 1906 may adapt the processors 1902 to perform some or a totality of features, functions, or operations disclosed herein for one or more of: capacitive sensor design to-be-distorted 100a, distorted capacitive sensor design 100b, system 1600, and system 1700. More specifically, features, functions, or operations disclosed herein for one or more of: sensor design application 1602, geometry distorter 1604, and transformer calculator 1606; and touch controller 1702, firmware 1710, irregular-shaped capacitive sensor 1704, regular shaped sensor detector 1706, and coordinates transformer 1708.

The processors 1902 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1906 (e.g., software code, firmware code, hardware descriptions) related to examples of the present disclosure. It is noted that a general-purpose processor (may also be referred to herein as a host processor or simply a host) may be a microprocessor, but in the alternative, the processors 1902 may include any conventional processor, controller, microcontroller, or state machine. The processors 1902 may also be implemented as a combination of computing devices, such as a combination of a DSP and a microprocessor, a plurality of microprocessors, one or more microprocessors in conjunction with a DSP core, or any other such configuration.

In some examples the storage 1904 includes volatile data storage (e.g., random-access memory (RAM)), non-volatile data storage (e.g., Flash memory, a hard disc drive, a solid state drive, erasable programmable read-only memory (EPROM), without limitation). In some examples the processors 1902 and the storage 1904 may be implemented into a single device (e.g., a semiconductor device product, a system on chip (SOC), without limitation). In some examples the processors 1902 and the storage 1904 may be implemented into separate devices.

In some examples the machine-executable code 1906 may include computer-readable instructions (e.g., software code, firmware code). By way of non-limiting example, the computer-readable instructions may be stored by the storage 1904, accessed directly by the processors 1902, and executed by the processors 1902 using at least the logic circuit 1908. Also by way of non-limiting example, the computer-readable instructions may be stored on the storage 1904, transferred to a memory device (not shown) for execution, and executed by the processors 1902 using at least the logic circuit 1908. Accordingly, in some examples the logic circuit 1908 includes electrically configurable logic circuit 1908.

In some examples the machine-executable code 1906 may describe hardware (e.g., circuitry) to be implemented in the logic circuit 1908 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog™ or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1908 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1906 may include an HDL, an RTL, a GL description, a mask level description, other hardware description, or any combination thereof.

In examples where the machine-executable code 1906 includes a hardware description (at any level of abstraction), a system (not shown, but including the storage 1904) implements the hardware description described by the machine-executable code 1906. By way of non-limiting example, the processors 1902 may include a programmable logic device (e.g., an FPGA or a PLC) and the logic circuit 1908 may be electrically controlled to implement circuitry corresponding to the hardware description into the logic circuit 1908. Also by way of non-limiting example, the logic circuit 1908 may include hard-wired logic manufactured by a manufacturing system (not shown, but including the storage 1904) according to the hardware description of the machine-executable code 1906.

Regardless of whether the machine-executable code 1906 includes computer-readable instructions or a hardware description, the logic circuit 1908 is adapted to perform the functional elements described by the machine-executable code 1906 when implementing the functional elements of the machine-executable code 1906. It is noted that although a hardware description may not directly describe functional elements, a hardware description indirectly describes functional elements that the hardware elements described by the hardware description are capable of performing.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. As used herein, “each” means some or a totality, and “each and every” means a totality.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method, comprising: changing a geometry of a capacitive sensor design from a first geometry to a second geometry, the second geometry different than the first geometry; and obtaining executable instructions to transform a location identifier of a touch event from a first location identifier associated with the first geometry to a second location identifier associated with the second geometry.

Example 2: The method according to Example 1, wherein the first geometry is a regular geometry, and the second geometry is an irregular geometry.

Example 3: The method according to and of Examples 1 and 2, wherein the changing the geometry of the capacitive sensor design from the first geometry to the second geometry comprises: obtaining a reference capacitive sensor design and a target capacitive sensor design, wherein the geometry of reference capacitive sensor design is the first geometry, and the geometry of the target capacitive sensor design is the second geometry; mapping the geometry of the reference capacitive sensor design to the geometry of the target capacitive sensor design; and setting respective node areas of the mapped reference capacitive sensor design to be uniform.

Example 4: The method according to any of Examples 1 to 3, wherein the mapping the geometry of the reference design to the geometry of the target design comprises: identifying, in the geometry of the target capacitive sensor design, constituent geometries that match predetermined geometries; dividing the geometry of the reference capacitive sensor design into rectangular sub-geometries, respective rectangular sub-geometries including respective identified ones of the constituent geometries of the target capacitive sensor design; for respective Y coordinates, calculating respective X coordinates of the identified constituent geometries; determining functions that describe relationships between the X coordinates of the constituent geometries and the X coordinates of the rectangular sub-geometries; and returning X and Y coordinates for the second geometry, and the functions.

Example 5: The method according to any of Examples 1 to 4, wherein the setting respective node areas of the mapped reference design to be uniform comprises: obtaining a scaling factor; and scaling dimensions of respective node areas of the mapped reference capacitive sensor design according to the scaling factor.

Example 6: The method according to any of Examples 1 to 5, comprising: finishing respective sensor node geometries of the mapped reference capacitive sensor design.

Example 7: The method according to any of Examples 1 to 6, wherein the finishing comprises: constructing rough sensor node geometries; smoothing curves of cut lines of rough node geometries; aligning respective crossover details of respective sensor node geometries; trimming gaps in cut lines; and returning finished sensor node geometries.

Example 8: The method according to any of Examples 1 to 7, wherein a scale of a reference coordinate line of the first geometry is different than a scale of a reference coordinate line of the second geometry.

Example 9: The method according to any of Examples 1 to 8, comprising: keeping a same number of sensor nodes of the capacitive sensor design between the first geometry and the second geometry; and keeping respective node areas of the one or more sensor nodes of the capacitive sensor design substantially uniform.

Example 10: The method according to any of Examples 1 to 9, wherein changing the geometry of the capacitive sensor design comprises one or more of: stretching, narrowing, or skewing the geometry of the capacitive sensor design or respective geometries of one or more sensor nodes thereof.

Example 11: The method according to any of Examples 1 to 10, comprising: defining the second geometry according to a geometry of a target touch surface.

Example 12: An apparatus, comprising: a storage device; and at least one processor to execute machine-executable instructions stored at the storage device, the machine-executable instructions to cause the at least one processor to: change a geometry of a capacitive sensor design from a first geometry to a second geometry, the second geometry different than the first geometry; and obtain executable instructions to transform a location identifier of a touch event from a first location identifier associated with the first geometry to a second location identifier associated with the second geometry.

Example 13: A method, comprising: receiving measurement signals from an irregular-shaped capacitive sensor during a capacitive measurement process; detecting capacitive changes indicative of a touch event at the irregular-shaped capacitive sensor; generating a location identifier associated with a location of the touch event; and changing the location identifier from a first location identifier value to a second location identifier value, the first location identifier value being associated with a regular geometry and the second location identifier value is associated with an irregular geometry.

Example 14: The method according to any of Example 13, wherein changing the location identifier from a first location identifier value to a second location identifier value comprises: generating a further location identifier having the second location identifier value associated with the irregular geometry.

Example 15: The method according to any of Examples 13 and 14, comprising: calculating the second location identifier value by applying a transform function to the first location identifier value.

Example 16: The method according to any of Examples 13 to 15, wherein the first location identifier value and the second location identifier value are XY coordinates.

Example 17: The method according to any of Examples 13 to 16, wherein the irregular-shaped capacitive sensor is a non-rectangular capacitive sensor.

Example 18: The method according to any of Examples 13 to 17, wherein sensor nodes of the irregular-shaped capacitive sensor exhibit a substantially uniform sensor area.

Example 19: The method according to any of Examples 13 to 18, wherein sensor nodes of the irregular-shaped capacitive sensor exhibit substantially non-uniform geometry.

Example 20: The method according to any of Examples 13 to 19, wherein a spacing between sensor nodes of the irregular-shaped capacitive sensor is non-uniform.

Example 21: The method according to Examples 13 to 20, wherein a number of sensor nodes in respective rows of the irregular-shaped capacitive sensor is uniform.

Example 22: The method according to any of Examples 13 to 21, wherein: sensor nodes of the irregular-shaped capacitive sensor exhibit a substantially uniform sensor area; sensor nodes of the irregular-shaped capacitive sensor exhibit substantially non-uniform geometry; a spacing between sensor nodes of the irregular-shaped capacitive sensor is non-uniform; and a number of sensor nodes in respective rows of the irregular-shaped capacitive sensor is uniform.

Example 23: An apparatus, comprising: a memory; and at least one processor to execute instructions stored at the memory, the instructions to cause the at least one processor to: receive measurement signals from an irregular-shaped capacitive sensor during a capacitive measurement process; detect capacitive changes indicative of a touch event at the irregular-shaped capacitive sensor; generate a location identifier associated with a location of the touch event; and change the location identifier from a first location identifier value to a second location identifier value, the first location identifier value being associated with a regular geometry and the second location identifier value is associated with an irregular geometry.

Example 24: The apparatus according to any of Example 23, wherein instructions to cause the at least one processor to change the location identifier from a first location identifier value to a second location identifier value include instructions to: generate a further location identifier having the second location identifier value associated with the irregular geometry.

Example 25: The apparatus according to any of Examples 23 and 24, wherein instructions to cause the at least one processor to change the location identifier from a first location identifier value to a second location identifier value include instructions to: calculate the second location identifier value by applying a transform function to the first location identifier value.

Example 26: A system, comprising: an irregular-shaped capacitive sensor; and a touch controller associated with the irregular-shaped capacitive sensor, the touch controller including: a first firmware to enable the touch controller to generate a first location identifier for a touch event that is associated with a regular-shaped capacitive sensor; and a second firmware to enable the touch controller to generate, at least partially based on the first location identifier, a second location identifier for the touch event that is associated with the irregular-shaped capacitive sensor.

Example 27: The system according to any of Example 26, wherein a surface of the irregular-shaped capacitive sensor has an irregular geometry.

Example 28: The system according to Examples 26 and 27, wherein the irregular geometry of the irregular-shaped capacitive sensor is a non-rectangular geometry.

Example 29: The system according to any of Examples 26 to 28, wherein the first location identifier value and the second location identifier value are XY coordinates.

Example 30: The system according to any of Examples 26 to 29, wherein the irregular-shaped capacitive sensor is a non-rectangular capacitive sensor.

Example 31: The system according to any of Examples 26 to 30, wherein sensor nodes of the irregular-shaped capacitive sensor exhibit a substantially uniform sensor area.

Example 32: The system according to any of Examples 26 to 31, wherein sensor nodes of the irregular-shaped capacitive sensor exhibit substantially non-uniform geometry.

Example 33: The system according to any of Examples 26 to 32, wherein a spacing between sensor nodes of the irregular-shaped capacitive sensor is non-uniform.

Example 34: The system according to Examples 26 to 33, wherein a number of sensor nodes in respective rows of the irregular-shaped capacitive sensor is uniform.

Example 35: The system according to any of Examples 26 to 34, wherein: sensor nodes of the irregular-shaped capacitive sensor exhibit a substantially uniform sensor area; sensor nodes of the irregular-shaped capacitive sensor exhibit substantially non-uniform geometry; a spacing between sensor nodes of the irregular-shaped capacitive sensor is non-uniform; and a number of sensor nodes in respective rows of the irregular-shaped capacitive sensor is uniform.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method, comprising:
changing a geometry of a capacitive sensor design from a first geometry to a second geometry, the second geometry different than the first geometry; and
obtaining executable instructions to transform a location identifier of a touch event from a first location identifier associated with the first geometry to a second location identifier associated with the second geometry.

2. The method of claim 1, wherein the first geometry is a regular geometry, and the second geometry is an irregular geometry.

3. The method of claim 1, wherein the changing the geometry of the capacitive sensor design from the first geometry to the second geometry comprises:
obtaining a reference capacitive sensor design and a target capacitive sensor design, wherein the geometry of reference capacitive sensor design is the first geometry, and the geometry of the target capacitive sensor design is the second geometry;
mapping the geometry of the reference capacitive sensor design to the geometry of the target capacitive sensor design; and
setting respective node areas of the mapped reference capacitive sensor design to be uniform.

4. The method of claim 3, wherein the mapping the geometry of the reference design to the geometry of the target design comprises:
identifying, in the geometry of the target capacitive sensor design, constituent geometries that match predetermined geometries;
dividing the geometry of the reference capacitive sensor design into rectangular sub-geometries, respective rectangular sub-geometries including respective identified ones of the constituent geometries of the target capacitive sensor design;
for respective Y coordinates, calculating respective X coordinates of the identified constituent geometries;
determining functions that describe relationships between the X coordinates of the constituent geometries and the X coordinates of the rectangular sub-geometries; and
returning X and Y coordinates for the second geometry, and the functions.

5. The method of claim 3, wherein the setting respective node areas of the mapped reference design to be uniform comprises:
obtaining a scaling factor; and
scaling dimensions of respective node areas of the mapped reference capacitive sensor design according to the scaling factor.

6. The method of claim 3, comprising: finishing respective sensor node geometries of the mapped reference capacitive sensor design.

7. The method of claim 6, wherein the finishing comprises:
constructing rough sensor node geometries;
smoothing curves of cut lines of rough node geometries;
aligning respective crossover details of respective sensor node geometries;
trimming gaps in cut lines; and
returning finished sensor node geometries.

8. The method of claim 1, wherein a scale of a reference coordinate line of the first geometry is different than a scale of a reference coordinate line of the second geometry.

9. The method of claim 1, comprising:
keeping a same number of sensor nodes of the capacitive sensor design between the first geometry and the second geometry; and
keeping respective node areas of the one or more sensor nodes of the capacitive sensor design substantially uniform.

10. The method of claim 1, wherein changing the geometry of the capacitive sensor design comprises one or more of: stretching, narrowing, or skewing the geometry of the capacitive sensor design or respective geometries of one or more sensor nodes thereof.

11. The method of claim 1, comprising:
defining the second geometry according to a geometry of a target touch surface.

12. An apparatus, comprising:
a storage device; and
at least one processor to execute machine-executable instructions stored at the storage device, the machine-executable instructions to cause the at least one processor to:
change a geometry of a capacitive sensor design from a first geometry to a second geometry, the second geometry different than the first geometry; and
obtain executable instructions to transform a location identifier of a touch event from a first location identifier associated with the first geometry to a second location identifier associated with the second geometry.

13. A method, comprising:
receiving measurement signals from an irregular-shaped capacitive sensor during a capacitive measurement process;
detecting capacitive changes indicative of a touch event at the irregular-shaped capacitive sensor;
generating a location identifier associated with a location of the touch event; and
changing the location identifier from a first location identifier value to a second location identifier value, the first location identifier value being associated with a regular geometry and the second location identifier value is associated with an irregular geometry.

14. The method of claim 13, wherein changing the location identifier from a first location identifier value to a second location identifier value comprises:
generating a further location identifier having the second location identifier value associated with the irregular geometry.

15. The method of claim 13, comprising:
calculating the second location identifier value by applying a transform function to the first location identifier value.

16. The method of claim 13, wherein the first location identifier value and the second location identifier value are XY coordinates.

17. The method of claim 13, wherein the irregular-shaped capacitive sensor is a non-rectangular capacitive sensor.

18. The method of claim 13, wherein sensor nodes of the irregular-shaped capacitive sensor exhibit a substantially uniform sensor area.

19. The method of claim 13, wherein sensor nodes of the irregular-shaped capacitive sensor exhibit substantially non-uniform geometry.

20. The method of claim 13, wherein a spacing between sensor nodes of the irregular-shaped capacitive sensor is non-uniform.

21. The method of claim 13, wherein a number of sensor nodes in respective rows of the irregular-shaped capacitive sensor is uniform.

22. The method of claim 13, wherein:
sensor nodes of the irregular-shaped capacitive sensor exhibit a substantially uniform sensor area;
sensor nodes of the irregular-shaped capacitive sensor exhibit substantially non-uniform geometry;
a spacing between sensor nodes of the irregular-shaped capacitive sensor is non-uniform; and
a number of sensor nodes in respective rows of the irregular-shaped capacitive sensor is uniform.

23. An apparatus, comprising:
a memory; and
at least one processor to execute instructions stored at the memory, the instructions to cause the at least one processor to:
receive measurement signals from an irregular-shaped capacitive sensor during a capacitive measurement process;
detect capacitive changes indicative of a touch event at the irregular-shaped capacitive sensor;
generate a location identifier associated with a location of the touch event; and
change the location identifier from a first location identifier value to a second location identifier value, the first location identifier value being associated with a regular geometry and the second location identifier value is associated with an irregular geometry.

24. The apparatus of claim 23, wherein instructions to cause the at least one processor to change the location identifier from a first location identifier value to a second location identifier value include instructions to:
generate a further location identifier having the second location identifier value associated with the irregular geometry.

25. The apparatus of claim 23, wherein instructions to cause the at least one processor to change the location identifier from a first location identifier value to a second location identifier value include instructions to:
calculate the second location identifier value by applying a transform function to the first location identifier value.

26. A system, comprising:
an irregular-shaped capacitive sensor; and
a touch controller associated with the irregular-shaped capacitive sensor, the touch controller including:
a first firmware to enable the touch controller to generate a first location identifier for a touch event that is associated with a regular-shaped capacitive sensor; and
a second firmware to enable the touch controller to generate, at least partially based on the first location identifier, a second location identifier for the touch event that is associated with the irregular-shaped capacitive sensor.

27. The system of claim 26, wherein a surface of the irregular-shaped capacitive sensor has an irregular geometry.

28. The system of claim 26, wherein the irregular geometry of the irregular-shaped capacitive sensor is a non-rectangular geometry.

29. The system of claim 26, wherein the first location identifier value and the second location identifier value are XY coordinates.

30. The system of claim 26, wherein the irregular-shaped capacitive sensor is a non-rectangular capacitive sensor.

31. The system of claim 26, wherein sensor nodes of the irregular-shaped capacitive sensor exhibit a substantially uniform sensor area.

32. The system of claim 26, wherein sensor nodes of the irregular-shaped capacitive sensor exhibit substantially non-uniform geometry.

33. The system of claim 26, wherein a spacing between sensor nodes of the irregular-shaped capacitive sensor is non-uniform.

34. The system of claim 26, wherein a number of sensor nodes in respective rows of the irregular-shaped capacitive sensor is uniform.

35. The system of claim 26, wherein:
sensor nodes of the irregular-shaped capacitive sensor exhibit a substantially uniform sensor area;
sensor nodes of the irregular-shaped capacitive sensor exhibit substantially non-uniform geometry;
a spacing between sensor nodes of the irregular-shaped capacitive sensor is non-uniform; and
a number of sensor nodes in respective rows of the irregular-shaped capacitive sensor is uniform.
